(19) United States
(12) Patent Application Publication
(10) Pub. No.: US 2018/0203516 A1
(43) Pub. Date: Jul. 19, 2018

(54) SENSE SHARED SYSTEM, OPERATION DEVICE, AND SENSE SHARED METHOD

(71) Applicant: HITACHI SYSTEMS, LTD., Tokyo (JP)

(72) Inventors: Hiroki TAKAMURA, Tokyo (JP); Kyohei MORIHIRO, Tokyo (JP); Masayuki TSUBOUCHI, Tokyo (JP)

(21) Appl. No.: 15/743,687

(22) PCT Filed: Jul. 14, 2015
(86) PCT No.: PCT/JP2015/070179

§ 371 Date: Feb. 6, 2018

(51) Int. Cl. G06F 3/01; G09B 15/00; G09B 5/14; G06K 9/00

(52) U.S. Cl. CPC G06F 3/017; G06K 9/00355; G09B 5/14; G09B 15/00

(57) ABSTRACT

Provided are a feeling share system, an operation device, and a feeling share method which are capable of reproducing a gesture without requiring a user to repeat the gesture. The present invention is provided with: a first operation device including a first operation interface unit that receives an operation from a first user, and a first communication unit that transmits, to a server device, first operation information indicating the operation received by the first operation interface unit; and a second operation device including a second communication unit that receives the first operation information from the server device, a second operation interface unit that receives an operation from a second user, and an operation control unit that reproduces the operation by using the second operation interface unit on the basis of the first operation information received by the second communication unit.

### TECHNICAL FIELD

The present invention relates to a sense shared system, an operation device, and a sense shared method.

### BACKGROUND ART

Conventionally, there have been various technologies for presenting information by a user performing a gesture. For example, in Patent Document 1, bidirectional content is output based on a positional parameter of a peripheral device operated by the user.

### CITATION LIST

### Patent Document

Patent Document 1: JP 2012-80533 A

### SUMMARY OF THE INVENTION

### Problems to be Solved by the Invention

In conventional technologies including the above-mentioned Patent Document 1, information is provided by a gesture (for example, a hand gesture). However, the user needs to perform a gesture to provide the information, and there is a problem that the user needs to repeat the gesture to reproduce the gesture.

The invention has been conceived in view of the above description, and an object of the invention is to provide a sense shared system, an operation device, and a sense shared method allowing a user to reproduce a gesture without repeating the gesture.

### Solutions to Problems

To solve the above-mentioned problem, a sense shared system according to the invention includes a first operation device including a first operation interface that receives an operation from a first user, and a first communication unit that transmits first operation information indicating the operation received by the first operation interface to a server device, and a second operation device including a second communication unit that receives the first operation information from the server device, a second operation interface that receives an operation from a second user, and an operation controller that reproduces the operation using the second operation interface based on the first operation information received by the second communication unit.

In addition, the invention is understood as the operation device used in the sense shared system and the sense shared method executed in the sense shared system.

### Effects of the Invention

According to the invention, it is possible to reproduce a gesture without a user repeating the gesture.

### BRIEF DESCRIPTION OF THE DRAWINGS

FIG. 1 is a diagram illustrating a configuration example of a sense shared system to which a sense shared system, an operation device, and a sense shared method according to the invention are applied.

FIG. 2 is a block diagram illustrating a functional configuration of the operation device.

FIG. 3 is a block diagram illustrating a functional configuration of a terminal device.

FIG. 4 is a diagram illustrating an example of data stored by a storage unit.

FIG. 5 is a diagram illustrating an example of an operation information table (table form).

FIG. 6 is a diagram showing an example of the operation information table (graph form).

FIG. 7 is a diagram illustrating an example of an operation correction table.

FIG. 8 is a block diagram illustrating a functional configuration of a server device.

FIG. 9 is a diagram illustrating an example of data stored by a server storage unit.

FIG. 10 is a diagram illustrating an example of an instruction operation information table.

FIG. 11 is a diagram illustrating an example of an operation correction history table.

FIG. 12 is a flowchart illustrating a processing procedure of a process of storing the instruction operation information table.

FIG. 13 is a flowchart illustrating a processing procedure of a comparative learning process.

FIG. 14 is a graph showing a value of an electric signal setting an operation value and time as axes.

FIG. 15 is a graph showing a value of an electric signal setting an operation value and time as axes (bar graph).

FIG. 16 is a diagram illustrating a state in which a modeled operation is displayed on a display unit 202.

FIG. 17 is a diagram illustrating an example of user information.

### MODE FOR CARRYING OUT THE INVENTION

Hereinafter, a detailed description will be given of an embodiment of a sense shared system, an operation device, and a sense shared method according to the invention with reference to accompanying drawings.

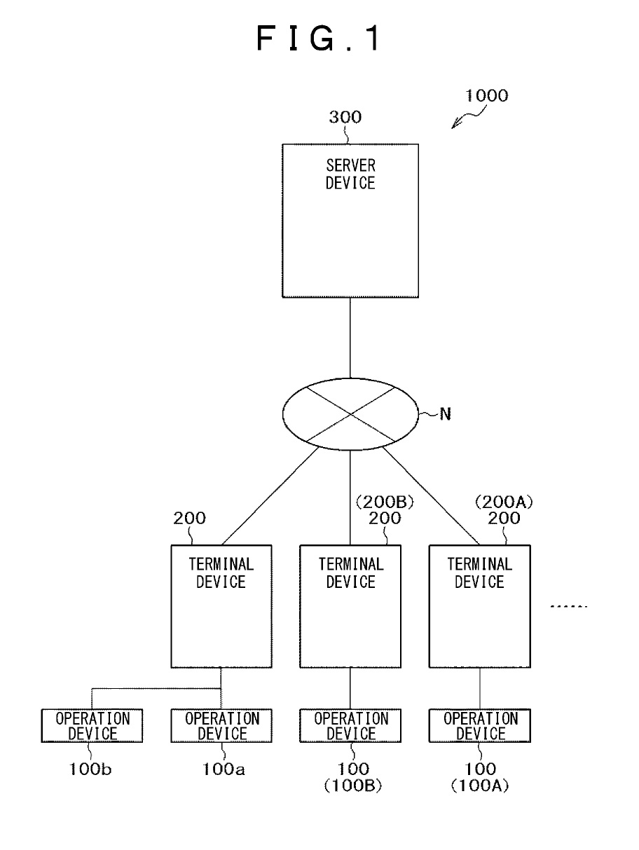

FIG. 1 is a diagram illustrating a configuration example of a sense shared system 1000 to which a sense shared system, an operation device, and a sense shared method according to the invention are applied. As illustrated in FIG. 1, the sense shared system 1000 includes an operation device 100 used by a user of this system, a terminal device 200 for controlling the operation device 100, and a server device 300 that manages the terminal device 200. Further, the terminal device 200 and the server device 300 are connected to each other through a network N.

The network N is a general public network such as the Internet. In addition, the operation device 100 and the terminal device 200 are connected to each other through a bus such as a universal serial bus (USB). Further, a plurality of operation devices 100 (for example, operation devices 100a and 100b) may be connected to the terminal device 200, and a plurality of terminal devices 200 may be connected to the server 300. In addition, hereinafter, a description will be given on the assumption that the operation device 100 and the terminal device 200 correspond to different housings. However, the devices may be configured as one housing.

In this system, an operation device 100 used by an instruction user (first user) corresponding to a user (for example, a teacher in a piano lesson) showing an operation corresponding to a model example is referred to as an operation device 100A, a terminal device 200 connected to the operation device 100A is referred to as a terminal device 200A, an operation device 100 used by an operation user (second user) corresponding to a user (for example, a student in the piano lesson) who performs an operation according to the model example shown by the instruction user is referred to as an operation device 100B, and a terminal device 200 connected to the operation device 100B is referred to a terminal device 200B. Hereinafter, these users are simply referred to as “users” when they are collectively referred to.

Further, hereinafter, a description will be given of a case in which an operation of the instruction user is transmitted to the operation user. However, an operation of the operation user may be transmitted to the instruction user. In other words, the first user and the second user may be appropriately exchanged for each other as necessary. In this case, the instruction user may detect the operation of the operation user. In addition, hereinafter, an example in which the user operates an operation target (for example, a piano) will be shown. However, conceptually, an action of the user (for example, running) may be included. First, the operation device 100 will be described.

The operation device 100 is a device for the user detecting and transmitting an operation (or feeling) based on a gesture of the user, and includes, for example, a possessed hand.

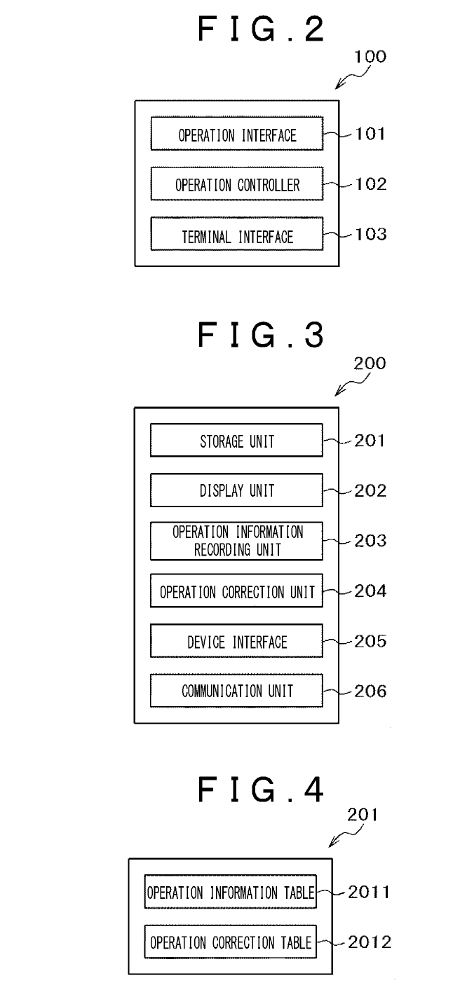

FIG. 2 is a block diagram illustrating a functional configuration of the operation device 100. As illustrated in FIG. 2, the operation device 100 includes an operation interface 101, an operation controller 102, and a terminal interface 103.

The operation interface 101 is an interface for transmitting an operation of the user to the operation device 100, and is mounted in a part (for example, each finger such as a thumb, a forefinger, etc.) of the user performing a gesture. The operation interface 101 converts the operation received from the user into an electric signal, and outputs the converted electric signal to the operation controller 102. In addition, the operation interface 101 receives an electric signal output from the operation controller 102 and operates the part. Hereinafter, an electric signal output by the operation interface 101 receiving an operation by the operation user so that the operation user operates each part is referred to as an operation electric signal. In addition, an electric signal output by the operation controller 102 and received by the operation interface 101 so that an operation of the instruction user is transmitted to a part of the operation user is referred to as an instruction electric signal. When these electric signals are collectively referred to, the electric signals are simply referred to as electric signals.

The operation controller 102 is a unit for outputting an electric signal to the operation interface 101 or the terminal interface 103. When an input electric signal corresponds to the operation electric signal, the operation controller 102 outputs the operation electric signal to the terminal interface 103. When an input electric signal corresponds to the instruction electric signal, the operation controller 102 outputs the instruction electric signal to the operation interface 101. In addition, the operation controller 102 controls an operation of each unit included in the operation device 100.

The terminal interface 103 is an interface for transmitting the operation electric signal output from the operation controller 101 to the terminal device 200 or receiving the instruction electric signal from the terminal device 200. A specific operation of each unit will be described below using a flowchart. Next, the terminal device 200 will be described.

The terminal device 200 includes a controller that controls the operation device 100 or an information processor such as a personal computer (PC).

FIG. 3 is a block diagram illustrating a functional configuration of the terminal device 200. As illustrated in FIG. 3, the terminal device 200 includes a storage unit 201, a display unit 202, an operation information recording unit 203, an operation correction unit 204, a device interface 205, and a communication unit 206.

For example, the storage unit 201 includes a general storage medium or storage device such as a memory chip, a disk, etc. and stores various data used in this system.

FIG. 4 is a diagram illustrating an example of data stored by the storage unit 201. As illustrated in FIG. 4, the storage unit 201 stores an operation information table 2011 and an operation correction table 2012.

FIG. 5 is a diagram illustrating an example of the operation information table 2011. The operation information table 2011 is a table that stores an electric signal received from each part through the operation interface 101 when the user performs a gesture. As illustrated in FIG. 5, in the operation information table 2011, an operation part corresponding to a part in which the user performs a gesture using the operation device 100 is associated with time indicating timing at which the gesture is performed by the operation part, and a value of an electric signal for each time and each part is stored.

For example, FIG. 5 illustrates that a value of an electric signal generated by a gesture of part 1 at time 1 corresponds to all, and an electric signal generated by a gesture of the part 1 at a time n corresponds to c1n. Similarly, FIG. 5 illustrates that a value of an electric signal generated by a gesture of part n at time 1 corresponds to cn1, and an electric signal generated by a gesture of part n at time n corresponds to enn. The operation information table 2011 is recorded by the operation information recording unit 203.

In FIG. 5, a value of an electric signal in an operation part is held in a table form. However, as illustrated in FIG. 6, the value of the electric signal may be plotted on a coordinate plane on which an operation value corresponding to a value of an electric signal and time are set as axes, and held in a graph form. In this way, when the value of the electric signal is held in the graph form and displayed, for example, on the display unit 202 such as a display by the operation recording unit 203, the user may detect the value (for example, strength of hitting a keyboard) or timing of the electric signal by the operation part in which the gesture is performed at a glance. FIG. 6 illustrates that a value of an electric signal in each of part 1 and part n gradually increases over time and becomes a maximum at timing of time 2/n. Similarly, FIG. 6 shows that a value of an electric signal in part 2 becomes a maximum value at timing of time n.

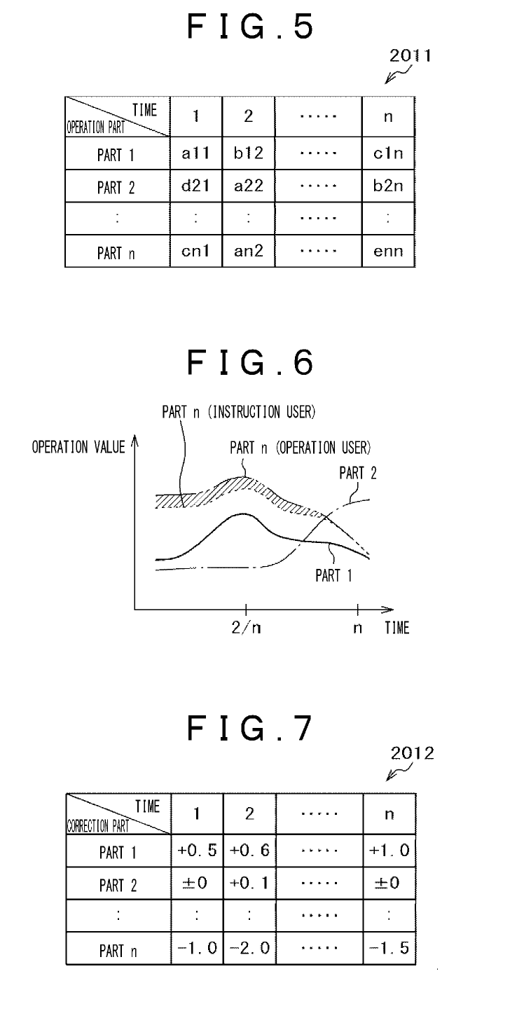

FIG. 7 is a diagram illustrating an example of the operation correction table 2012. The operation correction table 2012 is a table that stores a difference value between the operation electric signal based on the operation part of the operation user and the instruction electric signal based on the operation part of the instruction user. As illustrated in FIG. 7, in the operation correction table 2012, a correction part indicating an operation part corresponding to a correction target is associated with time indicating timing at which a gesture is performed by the correction part, and the difference value is stored for each time and each part.

For example, FIG. 7 illustrates that a difference value between a value of an operation electric signal generated by a gesture of part 1 at time 1 and a value of an instruction electric signal generated by a gesture of part 1 at time 1 is 0.5 (mV). That is, FIG. 7 illustrates that the value of the operation electric signal needs to be increased by 0.5 (mV) in order to correct the value of the operation electric signal generated by the gesture of part 1 at time 1 to the value of the instruction electric signal generated by the gesture of part 1 at time 1. Similarly, in order to correct a value of an operation electric signal generated by a gesture of part n at time 1 to a value of an instruction electric signal generated by a gesture of part n at time 1, the value of the operation electric signal needs to be decreased by 1.0 (mV). In this way, a difference value between an operation electric signal and an instruction electric signal is stored for each time and each part in the operation correction table 2012. The operation correction table 2012 is recorded by the operation correction unit 204.

Similarly to the operation information table 2011, the operation correction table 2012 may be held in a graph form. In this case, the difference value or timing may be detected at a glance. For example, as illustrated in FIG. 6, a range (shaded part) of a difference value of operation values corresponding to values of electric signals of part n of the operation user and part n of the instruction user may be plotted on the coordinate plane on which the operation value and time are set as axes, and held in the graph form. Next, returning to FIG. 3, each of subsequent units will be described from the display unit 202.

For example, the display unit 202 includes a display such as a liquid crystal display (LCD) and displays various types of information such as a table or a graph indicating a value of an electric signal at the time of operating the operation device 100 by the operation user or the instruction user, a table indicating a difference value between an operation electric signal and an instruction electric signal, etc. as described above.

The operation information recording unit 203 records an electric signal received from the operation device 100 for each time and each part with respect to each user to the operation information table 2011, and transmits the recorded operation information table 2011 to the server device 300 through the communication unit 206. Hereinafter, when an instruction electric signal is recorded in the operation information table 2011, the operation information table 2011 is transmitted to the server device 300. However, the operation information table 2011 in which the operation electric signal is recorded may be transmitted to the server device 300. It is possible to distinguish between the instruction user and the operation user by identifying a login ID obtained when the user logs in at the time of using this system, an ID assigned to the terminal device 200 or the operation device 100 in advance, etc.

The operation correction unit 204 compares the operation information table 2011 in which the value of the instruction electric signal received from the server device 300 is recorded with the operation information table 2011 in which the value of the operation electric signal received from the operation device 100 is recorded to obtain a difference value therebetween, records the value in the operation correction table 2012, and displays the recorded operation correction table 2012 on the display unit 202. In addition, the operation correction unit 204 of the terminal device 200 calibrates an operation of the operation device 100B based on the difference value. Further, the operation correction unit 204 transmits the recorded operation correction table 2012 to the server device 300. The transmitted operation correction table 2012 is accumulated for each user.

Hereinafter, the operation correction table 2012 is displayed on the display unit 202. However, the operation information table 2011 in which the value of the operation electric signal is recorded and the operation information table 2011 in which the value of the instruction electric signal is recorded may be displayed on the display unit 202. In this case, the operation user may confirm a value of an electric signal of each part of the instruction user corresponding to a model example, and easily detect a scheme of moving each part to perform a gesture by the instruction user and a difference with each part moved by the operation user.

The device interface 205 is an interface for transmitting the difference value obtained by the operation correction unit 204, the electric signal recorded by the operation information recording unit 203, and the electric signal received from the server device 300 to the operation device 100 or receiving the electric signal output from the operation device 100.

The communication unit 206 is an interface for receiving the electric signal from the server device 300 or transmitting the difference value or the electric signal to the server device 300. A specific operation of each of the above units will be described below using a flowchart. Next, the server device 300 will be described.

The server device 300 includes an information processor such as a server that manages the terminal device 200.

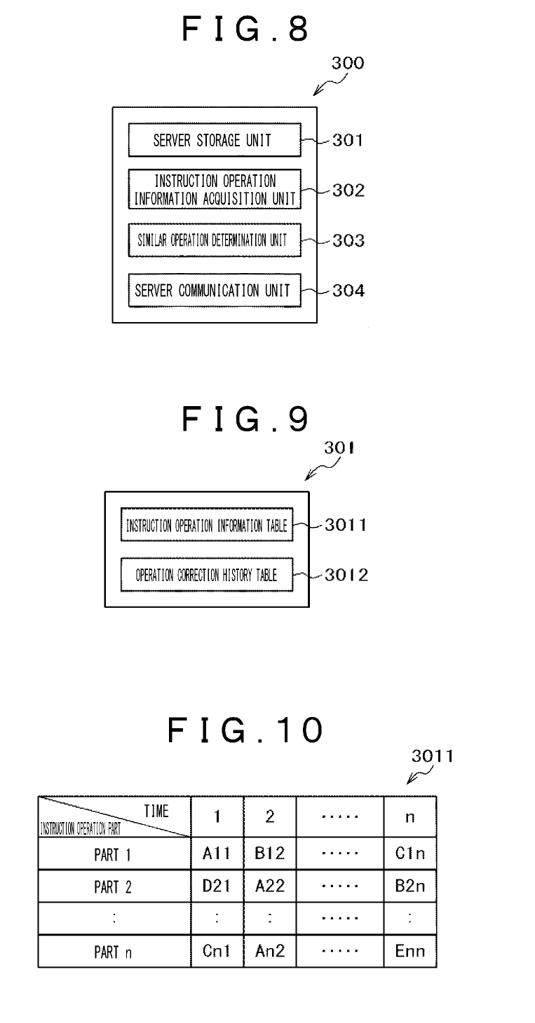

FIG. 8 is a block diagram illustrating a functional configuration of the server device 300. As illustrated in FIG. 3, the server device 300 includes a server storage unit 301, an instruction operation information acquisition unit 302, a similar operation determination unit 303, and a server communication unit 304.

Similarly to the storage unit 201, for example, the server storage unit 301 includes a general storage medium or storage device such as a memory chip, a disk, etc. and stores various data used in this system.

FIG. 9 illustrates an example of data stored by the server storage unit 301. As illustrated in FIG. 9, the server storage unit 301 stores an instruction operation information table 3011 and an operation correction history table 3012.

FIG. 10 is a diagram illustrating an example of the instruction operation information table 3011. The instruction operation information table 3011 is a table that stores an instruction electric signal received from each part when the instruction user performs a gesture using the operation device 100. A configuration of the instruction operation information table 3011 is similar to that of the operation information table 2011, and thus a description thereof will be omitted here. However, for example, FIG. 10 illustrates that a value of an instruction electric signal generated by a gesture in part 1 at time 1 corresponds to All, and an instruction electric signal generated by a gesture in part 1 at time n corresponds to C1n. Similarly, FIG. 10 illustrates that a value of an instruction electric signal generated by a gesture in part n at time 1 corresponds to Cn1, and an instruction electric signal generated by a gesture in part n at time n corresponds to Enn. The instruction operation information table 3011 is recorded by the instruction operation information acquisition unit 302.

In FIG. 10, a value of an electric signal in an operation part is held in a table form. Similarly to the case illustrated in FIG. 5, the value of the instruction electric signal may be plotted on a coordinate plane on which an operation value corresponding to a value of an instruction electric signal and time are set as axes, and held in a graph form. In this case, the instruction user may detect the value (for example, strength of hitting a keyboard) or timing of the instruction electric signal by the operation part in which the gesture is performed at a glance.

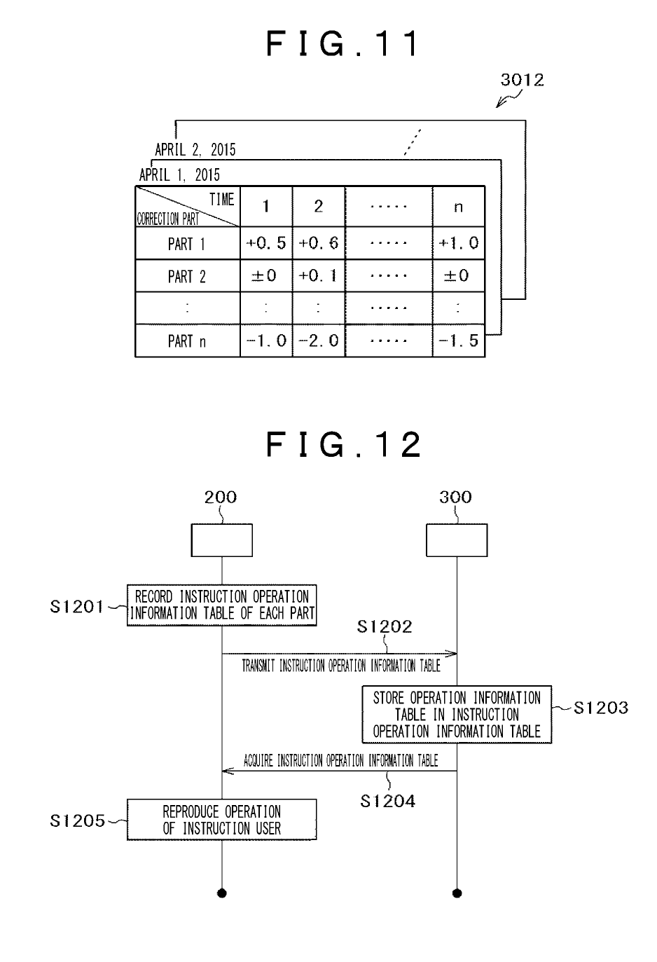

FIG. 11 is a diagram illustrating an example of the operation correction history table 3012. The operation correction table 3012 is a table that stores the operation correction table 2012 in a history form. As illustrated in FIG. 11, the operation correction history table 3012 is stored in the server storage unit 301 each time the operation correction table 2012 is recorded. A configuration of the operation correction history table 3012 is similar to that of the operation correction table 2012 illustrated in FIG. 7, and thus a description thereof will be omitted here. However, in FIG. 11, for example, with regard to a certain operation user, the operation correction table 2012 corresponding to each of Apr. 1, 2015 and Apr. 2, 2015 is stored in the operation correction history table 3012.

Similarly to the operation information table 2011, the operation correction table 2012, etc., the operation correction history table 3012 may be held in a graph form. In this case, the difference value or timing may be detected at a glance retroactively in the past. Next, returning to FIG. 8, a description will be given of each of subsequent units from the instruction operation information acquisition unit 302.

The instruction operation information acquisition unit 302 records the instruction electric signal, which is received from the terminal device 200 used by the instruction user through the server communication unit 304, in the instruction operation information table 3011. In addition, the instruction operation information acquisition unit 302 acquires an operation value of the instruction user stored in the instruction operation information table 3011 according to an instruction operation information acquisition request received from the terminal device 200 used by the operation user through the server communication unit 304, and transmits the operation value to the terminal device 200 transmitting the request through the server communication unit 304. In addition, the instruction operation information acquisition unit 302 records the difference value received from the terminal device 200 used by the operation user through the server communication unit 304 in the operation correction history table 3012.

In the present embodiment, the instruction operation information table 3011 is stored on the server device 300 side. However, the operation information table 2011 corresponding to a result of a gesture by each operation user may be received from the terminal device 200 to which each operation device 100 is connected and stored. In this way, when the operation information table 2011 is stored on the server device 300 side for each operation user, and the instruction operation information acquisition unit 302 compares the instruction operation information table 3011 with the operation information table 2011, it is possible to detect a degree of a difference in each operation between the instruction user and the operation user.

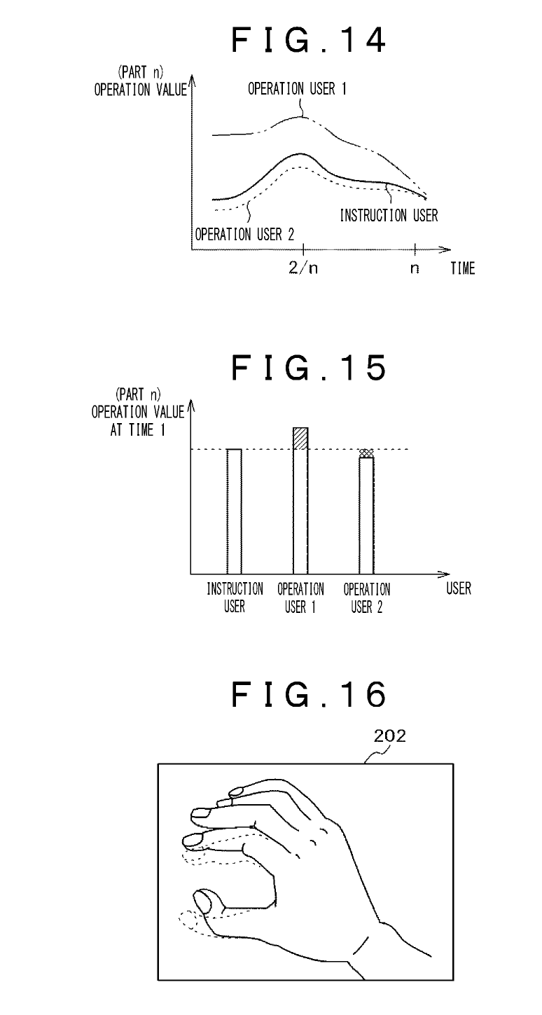

For example, as illustrated in FIG. 14, the value of the electric signal may be plotted on a coordinate plane on which an operation value corresponding to a value of an electric signal and time are set as axes for each part of the operation user or the instruction user, and held in a graph form. In this way, when the value of the electric signal is held in the graph form and displayed, for example, on the display unit 202 such as a display by the operation recording unit 203, the operation user or the instruction user may detect a difference from another operation user or a difference from another instruction user at a glance. FIG. 14 illustrates that a value of an electric signal in part n of operation user 1 is larger than that of an instruction user throughout the whole (for example, strength of hitting a keyboard is strong), and the value of operation user 2 is smaller than that of the instruction user throughout the whole (for example, strength of hitting the keyboard is weak).

Further, as illustrated in FIG. 15, the value of the electric signal may be held by a bar graph setting an operation value corresponding to a value of an electric signal and the user as axes for each time and each part of the operation user or the instruction user. In this way, when the value of the electric signal is held in the graph form and, for example, displayed on the display unit 202 such as the display by the operation recording unit 203, the operation user or the instruction user may detect a difference from another operation user or a difference from another instruction user at a certain time for each part at a glance. FIG. 15 illustrates that a value of an electric signal in part n at time 1 of operation user 1 is larger than that of an instruction user (for example, strength of hitting a keyboard is strong), and the value of operation user 2 is smaller than that of the instruction user (for example, strength of hitting the keyboard is weak).

When the instruction operation information acquisition unit 302 records the difference value in the operation correction history table 3012, the similar operation determination unit 303 refers to the recorded difference value and an operation value of the instruction user stored in the instruction operation information table 3011 to retrieve another instruction operation information table 3011 in which an operation value within a range of the difference value from the operation value of the instruction user is recorded, determines the other retrieved instruction operation information table 3011 in which the operation value within the range of the difference value is recorded to be an instruction operation information table 3011 including an operation value similar to an operation value operated by the operation user, and transmits the instruction operation information table 3011 to the terminal device 200 through the server communication unit 304.

That is, the similar operation determination unit 303 determines another instruction operation information table 3011 including an operation value within the range of the difference value (for example, an operation value when the instruction user performs an operation with respect to musical piece B) to be a similar instruction operation information table 3011 corresponding to a practice of the operation user based on an operation value of the instruction user (for example, an operation value when the instruction user performs an operation with respect to musical piece A), and transmits another instruction operation information table 3011 close to an operation value stored in the instruction operation information table 3011 with respect to the operation user as an easier instruction operation information table 3011 for practice to the terminal device 200. In this way, when the other instruction operation information table 3011 close to the operation value is transmitted to the terminal device 200 of the operation user transmitting the difference value, even in a case in which there is a gap between the operation value of the operation user and the operation value of the instruction operation information table 3011, it is possible to perform an operation using the other instruction operation information table 3011 storing an operation value within the range between the difference value and the operation value of the instruction operation information table 3011. Thus, it is possible to perform practice to approximate to the operation value of the instruction operation information table 3011 which is initially aimed step by step.

The server communication unit 304 is an interface for transmitting the instruction operation information table 3011 or another instruction operation information table 3011 to the terminal device 200 or receiving the acquisition request or the difference value from the terminal device 200. A specific operation of each of the above units will be described below using a flowchart.

In practice, for example, each of the above units is implemented by executing a program installed in the operation device 100 having a controller such as a central processing unit (CPU) or a computing device, the terminal device 200, and the server device 300.

The program may be provided by being incorporated in a read only memory (ROM), etc. in advance, provided by being recorded in a computer-readable recording medium such as a CD-ROM, a CD-R, a digital versatile disk (DVD), etc. in a file of an installable format or an executable format, or distributed. Further, the program may be provided by being stored on a computer connected to a network such as the Internet and downloaded via the network, or distributed. Next, a process performed in this system will be described.

FIG. 12 is a flowchart illustrating a processing procedure of a process for storing the operation value of the instruction user in the instruction operation information table 3011 (an instruction operation information table storing process) performed in this system. As illustrated in FIG. 12, in the instruction operation information table storing process, first, the operation information recording unit 203 of the terminal device 200 used by the instruction user records the operation value of each part in the operation information table 2011 (S1201). In practice, for example, the operation information recording unit 203 records, in the operation information table 2011, the operation value in association with a login ID obtained by logging in when the instruction user uses this system or an ID previously assigned to the terminal device 200 or the operation device 100 used by the instruction user.

The operation information recording unit 203 transmits the operation information table 2011 in which the operation value is recorded to the server device 300 through the communication unit 204 (S1202), and the instruction operation information acquisition unit 302 of the server device 300 records the operation information table 2011 received from the terminal device 200 used by the instruction user in the instruction operation information table 3011 (S1203). In this instance, the instruction operation information acquisition unit 302 compares an ID associated with the operation information table 2011 received from the terminal device 200 with a user registered in the system as the instruction user in advance, and determines that the user corresponds to the instruction user. When processing of S1203 ends, the instruction operation information storing process illustrated in FIG. 12 ends, and the operation information table 2011 is stored as the instruction operation information table 3011 in the server device 300 and shared in the system.

Thereafter, the operation information recording unit 203 of the terminal device 200 connected to the operation device 100 operated by the operation user acquires the instruction operation information table 3011 stored in the server device 300 by download, etc. (S1204), and the operation controller 102 of the operation device 100 reads the instruction operation information table 3011 acquired by the terminal device 200 and outputs the operation value stored in the read instruction operation information table 3011, thereby reproducing an operation of the instruction user (S1205).

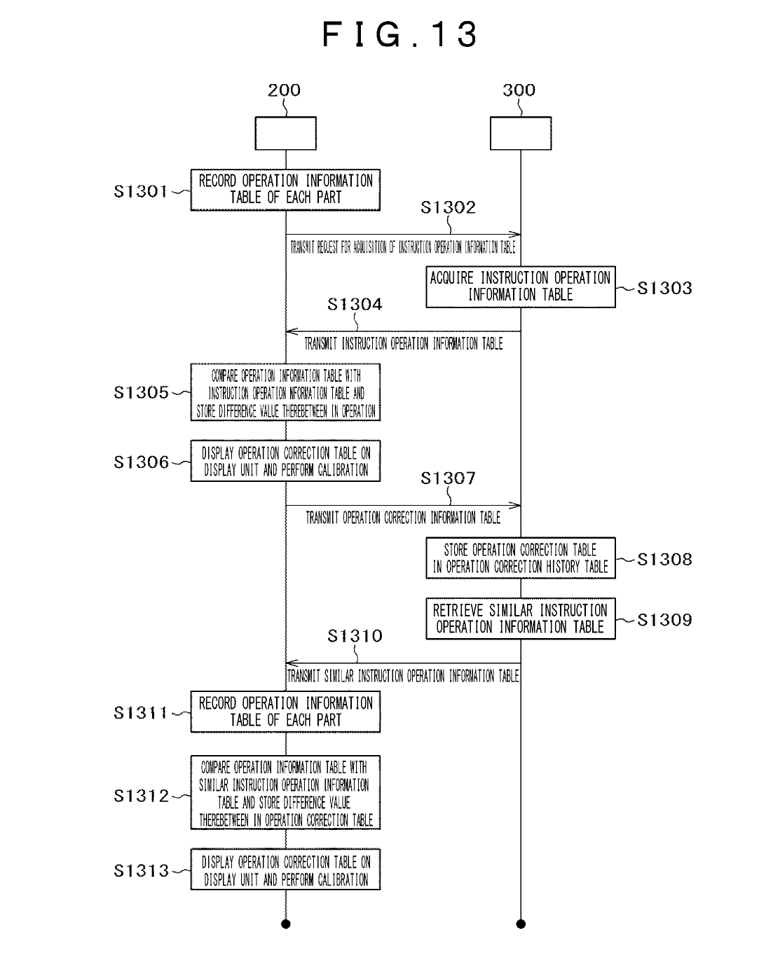

FIG. 13 is a flowchart illustrating a processing procedure of a process (comparative learning process) of comparing the operation value of the instruction user with the operation value of the operation user and presenting a difference therebetween performed in this system. As illustrated in FIG. 13, in the comparative learning process, first, upon recording the operation value of each part (S1301), the terminal device 200 of the operation user transmits a request for acquisition of the instruction operation information table 3011 to the server device 300 (S1302).

The instruction operation information acquisition unit 302 of the server device 300 acquires the corresponding instruction operation information table 3011 according to the acquisition request, and transmits the acquired instruction operation information table 3011 to the terminal device 200 (S1303 and S1304). For example, the corresponding instruction operation information table 3011 refers to an instruction operation information table 3011 including the operation value of the instruction user (for example, the operation value when the instruction user performs an operation with respect to musical piece A) corresponding to the operation value of the operation user (for example, the operation value when the operation user performs an operation with respect to musical piece A).

The terminal device 200 receiving the instruction operation information table 3011 compares the operation information table 2011 recorded in S1301 with the instruction operation information table 3011 received in S1304, records a difference value therebetween in the operation correction table 2012 (S1305), and displays the operation correction table 2012 on the display unit (S1306). In this instance, the operation correction unit 204 of the terminal device 200 calibrates an operation of the operation device 100B based on the difference value. Such calibration enables the operation user to sensuously detect a degree of a gap between the operation value of the instruction user and the operation value of the operation user directly through a skin of the operation user.

It suffices when the operation user approximates to the operation of the instruction user by the calibration. However, there may be a case in which improvement is not achieved merely by calibrating the operation device 100 based on the difference value with respect to the instruction operation information table 3011 depending on the proficiency degree of the operation user. Therefore, the operation correction unit 204 transmits the operation correction table 2012 to the server device 300 (S1307).

The instruction operation information acquisition unit 302 of the server device 300 stores the received operation correction table 2012 in the operation correction history table 3012 (S1308), and the similar operation determination unit 303 retrieves another instruction operation information table 3011, in which an operation value within the range of difference value stored in the operation correction table 2012 from the operation value stored in the instruction operation information table 3011 is recorded, with reference to the stored operation correction table 2012 and the stored instruction operation information table 3011 (S1309), determines that the other retrieved instruction operation information table 3011 to be the instruction operation information table 3011 including an operation value similar to the operation value operated by the operation user, and transmits the instruction operation information table 3011 to the terminal device 200 (S1310).

The operation information recording unit 203 of the terminal device 200 compares the instruction operation information table 3011 including the similar operation value received from the server device 300 with the operation information table 2011 recorded in S1301, records the difference value in the operation correction table 2012 (S1311, S1312), and displays the operation correction table 2012 on the display unit (S1313) similarly to the case of S1305 and S1306.

In this instance, the operation correction unit 204 of the terminal device 200 calibrations the operation of the operation device 100B based on the newly received difference value. Such calibration enables the operation user to learn an operation of the instruction user step by step based on the operation value of the instruction user having a small degree of a gap with respect to the operation value of the operation user. The operation user may learn the operation of the instruction user intensively and step by step by repeating the above steps until the operation user is convinced. When processing of S1313 ends, the comparative learning process illustrated in FIG. 13 ends.

As described above, in this system, when the above respective processes are performed to store the operation value of the instruction user in the server device, and the operation user or the instruction user receives the instruction operation information table including the operation value and outputs the operation value, it is possible to easily reproduce the operation value of the instruction user corresponding to a model example without the instruction user performing an operation every time.

In addition, when the difference value between the operation value of the operation user and the operation value of the instruction user is indicated, the operation user sensuously detects a difference in operation from the instruction user. Further, when an electric signal indicating the difference value is transmitted to the operation device 100 and calibrated, it is possible to assist in approximating the operation of the operation user to the operation of the instruction user. Furthermore, even when there is a gap between the operation of the operation user and the operation of the instruction user, since calibration is performed based on a difference value thereof, the operation user may operate the operation device by feeling as though the instruction user was performing an operation.

Further, even in a case in which there is a gap in an operation between the operation user and the instruction user since the instruction operation information table including the operation value similar to the operation value of the instruction user corresponding to a model example is retrieved and presented to the operation user such as a case in which improvement may not be achieved, it is possible to approximate to the operation of the instruction user step by step.

In the above embodiment, a description has been given of a case in which the operation device 100 is calibrated based on the difference value between the operation value of the operation user and the operation value of the instruction user. However, in this system, the operation correction table 2012 of the operation user or the instruction user is accumulated in a history as the operation correction history table 3012 in the server device 300. Therefore, the terminal device 200 receives the operation correction history table 3012 from the server device 300, and the operation user may detect the degree of the gap between the operation value of the operation user and the operation value of the instruction user in time series and check a progress condition of the operation user.

In addition, a certain operation user may receive an operation correction history table 3012 of another operation user from the server device 300, compare an operation value of the other operation user with an operation value of the certain operation user, and objectively detect an operation of the certain operation user. Further, for the instruction user, it is possible to check a progress condition of each operation user, easily detect strong and weak points of the operation user, and feed back a result thereof. In the present embodiment, a description is given on the assumption that the operation correction history table 3012 is stored in a history in the server device 300. However, the operation information table 2012 may be received from the terminal device 200 by the server device 300 and stored in a history similarly to the operation correction history table 3012. In this case, as described above, own operation may be detected by an operation value rather than a difference value.

In addition, in the above embodiment, the operation information table 2011, the operation correction table 2012, or the value of the electric signal is displayed on the display unit 202. However, in order to make is easy for the operation user to understand, from these tables or the value of the electric signal, an operation by the operation device of each of the instruction user and the operation user may be modeled and displayed on the display unit 202 or scored using various schemes and then displayed on the display unit 202.

FIG. 16 is a diagram illustrating a state in which a modeled operation is displayed on the display unit 202. An example illustrated in FIG. 16 shows that a difference in operation value between the instruction user and the operation user is generated on a thumb and a forefinger. Along with such a display, an actual difference value may be displayed in association with a finger having a difference (in the vicinity of the thumb and the forefinger in FIG. 16).

Further, in this system, a description is given on the assumption that the instruction user or the operation user logs in to use the system. To use this system by logging in, user information including the user or the operation device may be registered in the server device 300 in advance.

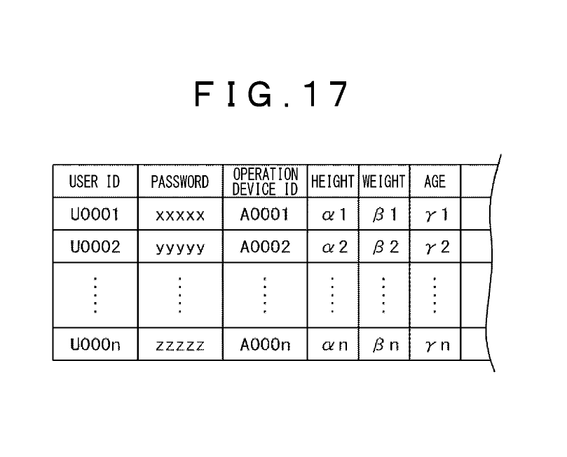

FIG. 17 is a diagram illustrating an example of the user information. As illustrated in FIG. 17, in the user information, for example, a user ID and a password for identifying the instruction user or the operation user, an operation device ID for identifying the operation device of the user, and information indicating physical features such as a height, a weight, an age, etc. of the user are associated with one another and stored. In FIG. 17, for example, a user identified by a user ID “U0001” and a password “xxxxx” operates an operation device identified by an operation device ID “A0001”, and a height, a weight, an age correspond to α1, β1, and γ1, respectively.

In this way, when the user information is registered, and the operation information table 2011, the operation correction table 2012, and the value of the electric signal are associated with one another and stored in the server device 300, it is possible to analyze a relationship between the operation user (or the instruction user) and an actual operation from various angles. For example, when an operation user having a physical feature has an operation tendency among a plurality of operation users, it is possible to analyze the physical feature and the operation tendency.

In the above embodiment, as an example of an operation by a user, a description has been given of a case in which the instruction user corresponding to the teacher in the piano lesson and the student corresponding to the operation user play the piano as an operation. However, the invention is not limited thereto. This system may be utilized in various scenes in which an operation or a feeling may be transmitted by mounting an operation device on each part of the user regardless of industry. For example, the operation device may be mounted on a leg or an arm of a competition leader corresponding to the instruction user to show a model example of various exercises such as how to run to an athlete corresponding to the operation user, a parent corresponding to the instruction user may show a model example of various daily activities such as how to hold chopsticks to a child corresponding to the operation user, or the instruction user corresponding to a medical worker may show a model example of rehabilitation to the operation user corresponding to a patient.

The invention is not limited to the above embodiment without change, and may be embodied by modifying a constituent element within a range not departing from subject matter in an implementation stage. In addition, it is possible to form an invention obtained by combining a plurality of constituent elements disclosed in each of the above embodiments.

For example, in the above embodiment, the instruction operation information table, etc. is stored in the server device 300 and shared in the system. However, after the operation device or the terminal device used by the instruction user is set as a master, and the operation device or the terminal device used by the operation user is set as a slave, the instruction operation information table, etc. may be stored in the terminal device used by the instruction user and directly accessed from the operation device or the terminal device used by the operation user. In this way, one or a plurality of functions of the server device 300 may be held in the operation device or the terminal device used by the instruction user. In this case, the server device 300 may not be provided, and thus the above effect may be obtained by a simpler configuration.

### REFERENCE SIGNS LIST

1000: sense shared system

100: operation device

101: operation interface

102: operation controller

103: terminal interface

200: terminal device

201: storage unit

2011: operation information table

2012: operation correction table

202: display unit

203: operation information recording unit

204: operation correction unit

205: device interface

206: communication unit

300: server device

301: server storage unit

3011: instruction operation information table

3012: operation correction history table

302: instruction operation information acquisition unit

303: similar operation determination unit

304: server communication unit

N: network

1. A sense shared system comprising:
a first operation device including
a first operation interface that receives an operation from a first user, and
a first communication unit that transmits first operation information indicating the operation received by the first operation interface to a server device; and
a second operation device including
a second communication unit that receives the first operation information from the server device,
a second operation interface that receives an operation from a second user, and
an operation controller that reproduces the operation using the second operation interface based on the first operation information received by the second communication unit.

2. The sense shared system according to claim 1, wherein the second operation device further includes
an operation correction unit that corrects an operation reproduced using the second operation interface to the operation indicating the first operation information based on a difference between the first operation information and second operation information indicating the operation received by the second operation interface.

3. The sense shared system according to claim 2, wherein
in the first operation device,
the first operation interface receives a plurality of first operation information items indicating operations other than the operation, and
the first communication unit transmits the plurality of first operation information items indicating the other operations to the server device, and
in the second operation device,
the second communication unit transmits operation correction information indicating the difference to the server device, and receives the first operation information having the difference within a predetermined range among the plurality of first operation information items indicating the other operations from the server device, and
the operation correction unit corrects an operation reproduced using the second operation interface to the operation indicating the first operation information having the difference within the predetermined range based on a difference between the first operation information having the difference within the predetermined range and the second operation information.

4. The sense shared system according to claim 1, wherein
the first operation interface and the second operation interface receive inputs for each part of the first user and each part of the second user, respectively, and
the operation controller reproduces the operation for each part.

5. An operation device comprising:
a communication unit that receives first operation information from a server device, the first operation information indicating an operation from a first user possessed by a first operation device, a first operation interface receiving the operation;
a second operation interface that receives an operation from a second user;
an operation controller that reproduces the operation using the second operation interface based on the first operation information received by the communication unit; and
an operation information recording unit that displays the first operation information and the second operation information on a display unit.

6. The operation device according to claim 5, wherein the operation recording unit displays a difference between the first operation information and the second operation information on the display unit.

7. The sense shared system according to claim 5, wherein
the first operation interface and the second operation interface receive inputs for each part of the first user and each part of the second user, respectively,
the operation controller reproduces the operation for each part, and
the operation recording unit performs a display on the display unit for each part.

8. The operation device according to claim 5,
wherein the communication unit receives first operation information items with respect to a plurality of first users from the server device, and
the operation information recording unit displays the first operation information items with respect to the plurality of first users and the second operation information on the display unit.

9. A sense shared method comprising:
a first operation step of receiving an operation from a first user;
a first communication step of transmitting first operation information indicating the operation received in the first operation step to a server device;
a second communication step of receiving the first operation information from the server device;
a second operation step of receiving an operation from a second user; and
an operation control step of reproducing the operation using the second operation interface based on the first operation information received in the second communication step.

10. The sense shared method according to claim 9, further comprising
an operation correction step of correcting the operation reproduced using the second operation interface to the operation indicating the first operation information based on a difference between the first operation information and second operation information indicating the operation received in the second operation step when the first operation step and the second operation step are performed.

11. The sense shared method according to claim 10, wherein
a plurality of first operation information items indicating operations other than the operation is received in the first operation step,
the plurality of first operation information items indicating the other operations is transmitted to the server device in the first communication step,
operation correction information indicating the difference is transmitted to the server device, and first operation information having the difference within a predetermined range among the plurality of first operation information items indicating the other operations is received from the server device in the second communication step, and
the operation reproduced using the second operation interface to an operation indicating the first operation information having the difference within the predetermined range based on a difference between the first operation information having the difference within the predetermined range and the second operation information in the operation correction step.

12. The sense shared method according to claim 9, wherein
inputs are received for each part of the first user and each part of the second user in the first operation step and the second operation step, respectively, and
the operation is reproduced for each part in the operation control step.
